(19) United States
(12) Patent Application Publication
(10) Pub. No.: US 2013/0180511 A1
(43) Pub. Date: Jul. 18, 2013

(54) METHOD FOR OPERATING AN INTERNAL COMBUSTION ENGINE HAVING MULTIPLE COMBUSTION CHAMBERS, AND INTERNAL COMBUSTION ENGINE HAVING MULTIPLE COMBUSTION CHAMBERS

(71) Applicants: Werner Hess, Stuttgart (DE); Klaus Ries-Mueller, Bad Rappenau (DE)

(72) Inventors: Werner Hess, Stuttgart (DE); Klaus Ries-Mueller, Bad Rappenau (DE)

(21) Appl. No.: 13/812,584

(22) PCT Filed: Jun. 27, 2011
(86) PCT No.: PCT/EP11/60707

§ 371 Date: Apr. 4, 2013

(30) Foreign Application Priority Data
Aug. 2, 2010 (DE) 102010038779.7

(51) Int. Cl. F02B 17/00

(52) U.S. Cl. CPC F02B 17/005
USPC 123/704

(57) ABSTRACT

In a method for operating an internal combustion engine having multiple combustion chambers and an injector for injecting fuel associated with at least one combustion chamber, an excess air factor which is individual for each combustion chamber is adjusted for the at least one combustion chamber, and a torque which is individual for each combustion chamber is ascertained for the at least one combustion chamber. A control period of the injector is adapted for the injector by ascertaining a valve opening period in such a way that tolerances of the injector are at least essentially compensated for with respect to a relationship between the control period and the valve opening period.

### BACKGROUND OF THE INVENTION

1. Field of the Invention

The present invention relates to a method for operating an internal combustion engine having multiple combustion chambers, an injector for injecting fuel into the combustion chamber being associated with at least one combustion chamber, an excess air factor which is individual for each combustion chamber being adjusted for at least one combustion chamber, and/or a torque which is individual for each combustion chamber being ascertained for at least one combustion chamber.

2. Description of the Related Art

A method and a device are known from published European patent document EP 1 169 560 B1 for determining cylinder-individual differences of a control variable for a multicylinder internal combustion engine, for example a gasoline engine having direct gasoline injection. This method includes a cylinder-individual lambda regulation via which the cylinder-individual air ratios may be regulated to a certain value. Moreover, the method includes the determination of cylinder-individual torque contributions of the individual cylinders. The known method is adaptive in the sense that it adapts, for example, to manufacturing-related tolerances between the individual cylinders. However, for detecting sensor signals which are used for this adaptation, only one sensor that is shared by all cylinders, for example a shared lambda sensor or a shared rotation angle sensor, is present in internal combustion engines which are usually used, so that the adaptation is relatively inaccurate, possibly resulting in faulty adaptations.

### BRIEF SUMMARY OF THE INVENTION

The present invention achieves the object of providing a method for operating an internal combustion engine via which, for individual combustion chambers, specific properties may be detected and, if necessary, compensated for, with the aim of avoiding faulty adaptations to the greatest extent possible. The object also includes providing a corresponding internal combustion engine.

To achieve this object, a method is proposed for operating an internal combustion engine of the type stated at the outset, characterized in that a control period of the injector is adapted for at least one injector by detecting or ascertaining a valve opening period of the injector in such a way that tolerances of the injector are at least essentially compensated for with respect to a relationship between the control period and the valve opening period. Since a fuel quantity injected into the combustion chamber is generally a function of the control period, this adaptation ensures, at least in most cases, that tolerances of the injector are at least partially compensated for with respect to a relationship between the control of the injector and the fuel quantity. As a result, differences between the individual combustion chambers involving the charge (mass of fresh gas introduced into the combustion chamber within a gas exchange cycle) and involving the fuel quantity injected into the individual combustion chambers with the aid of the injector may be adapted separately. In this regard, it is preferred that adapting the control period is carried out with a higher priority than other adaptation processes, for example the lambda regulation for individual cylinders, or optionally, a control of the torque for individual combustion chambers.

Differences between the individual injectors, which may result from manufacturing tolerances or aging processes, for example, may thus be recognized and corrected in a particularly effective manner.

It is preferred that in adapting the control period, at least one valve delay time of the injector is ascertained by detecting and evaluating a variation over time of at least one electrical variable for an electrically activated actuator of the injector, preferably a current through the actuator. For example, the current through a coil of an electromagnetic actuating device of the injector may be detected. The valve delay time corresponds to a time for the valve to respond to a control signal for opening or closing the injector. The ascertained valve delay time may be used to form a control signal in order to open the injector at the correct point in time, for the correct valve opening period.

An opening delay time between a start of a control for opening the injector and an actual opening of the injector, and/or a closing delay time between a start of a control for closing the injector and an actual closing of the injector, is/are preferably ascertained as the valve delay time. The start of the control for opening the injector may, for example, correspond to a start of an energization of the coil of the injector. Accordingly, the start of a control for closing the injector may correspond to an end of the energization of the coil.

The valve delay time is thus detected directly at the actuator of the injector. The actuator of the injector is thus likewise used as a sensor which is used to detect the valve delay time. For example, the end of a motion of a valve element of the injector may be directly detected by evaluating the electrical variable, for example the current. Thus, it is not necessary to resort to sensor variables, which are only indirectly related to the motion of the valve element, i.e., the opening and closing of the injector, and/or which are jointly detected for multiple or all combustion chambers of the internal combustion engine. The method therefore has the advantage that tolerances of the valve delay time may be detected directly at their source, and corrected if necessary. This results in high accuracy and reliability of the method. It may be provided that the valve opening period of the injector (period of time during which the injector is open) is computed based on the control period (period of time between the control for opening the injector and the control for closing the injector), which is known by a control unit of the internal combustion engine, and the valve delay times.

It may be provided that a check is made as to whether an adaptation operation for adapting the control period has reached a steady state, and the torque which is individual for each combustion chamber is not ascertained until this check has shown that the adaptation operation has reached a steady state. In this way, on the one hand the adaptation of the fuel quantity may be carried out with a comparatively high priority, and on the other hand, deviations among the individual injectors regarding the fuel quantity or the valve delay time are initially corrected before an attempt is made to recognize and/or compensate for deviations in the charge of the individual combustion chambers.

It may also be provided that a control operation for controlling the excess air factor which is individual for each combustion chamber is not started until the check as to whether the adaptation operation has reached a steady state has shown that the adaptation operation has reached a steady state. Thus, a higher priority is assigned to the adaptation operation than to the control operation for controlling the excess air factor which is individual for each combustion chamber.

It may also be provided that a check is made as to whether the control operation for controlling the excess air factor which is individual for each combustion chamber has reached a steady state, and the torque which is individual for each combustion chamber is not ascertained until this check has shown that the control operation has reached a steady state. Errors in ascertaining the torque which is individual for each combustion chamber, which may result from the excess air factor not yet being adjusted to a predefined value of λₛₑₜₚₒᵢₙₜ=1, for example, are thus avoided.

It is preferred that in ascertaining the torque which is individual for each combustion chamber, at least one sensor variable is detected which characterizes a combustion chamber pressure in the particular combustion chamber, a rotation angle of a shaft, for example a crankshaft or a camshaft, of the internal combustion engine, and/or a rotational speed of the shaft of the internal combustion engine. In the case of the rotation angle or the rotational speed, the torque may be ascertained, for example, by detecting or ascertaining a change in the rotational speed in a period of time in which the particular combustion chamber being observed contributes to generation of the overall torque of the internal combustion engine.

It is preferred that in ascertaining the torque which is individual for each combustion chamber, a variable which characterizes uneven running of the internal combustion engine is computed. The greater the differences among the torques which are individual for each combustion chamber, the higher the level of uneven running of the internal combustion engine.

As a further approach to achieving the above-stated object, an internal combustion engine having multiple combustion chambers is proposed, an injector for injecting a fuel quantity into the combustion chamber being associated with at least one combustion chamber, and for at least one combustion chamber the internal combustion engine, preferably a control unit for controlling and/or regulating the internal combustion engine, being set up for adjusting, for at least one combustion chamber, an excess air factor which is individual for each combustion chamber, and for ascertaining, for at least one combustion chamber, a torque which is individual for each combustion chamber and which preferably corresponds to a contribution to an overall torque on a shaft of the internal combustion engine, which is characterized in that the internal combustion engine or the control unit is set up and/or designed in such a way that by detecting or ascertaining a valve opening period of the injector for at least one injector, a control period of the injector is adapted in such a way that tolerances of the injector are at least essentially compensated for with respect to a relationship between the control period and the valve opening period. The advantages of the method according to the present invention may be achieved with the aid of such an internal combustion engine.

It is particularly preferred that the internal combustion engine or the control unit is set up, preferably programmed, for carrying out an above-described method according to the present invention. For this purpose, the control unit may have a computer, for example a microcontroller, which contains a memory element in which a program for carrying out a method according to the present invention is stored.

Further features and advantages of the present invention result from the following description, in which specific exemplary embodiments of the present invention are explained in greater detail with reference to the drawings.

### BRIEF DESCRIPTION OF THE DRAWINGS

FIG. 1 shows an internal combustion engine in a schematic illustration.

FIG. 2 shows a flow chart of a method for operating the internal combustion engine from FIG. 1.

### DETAILED DESCRIPTION OF THE INVENTION

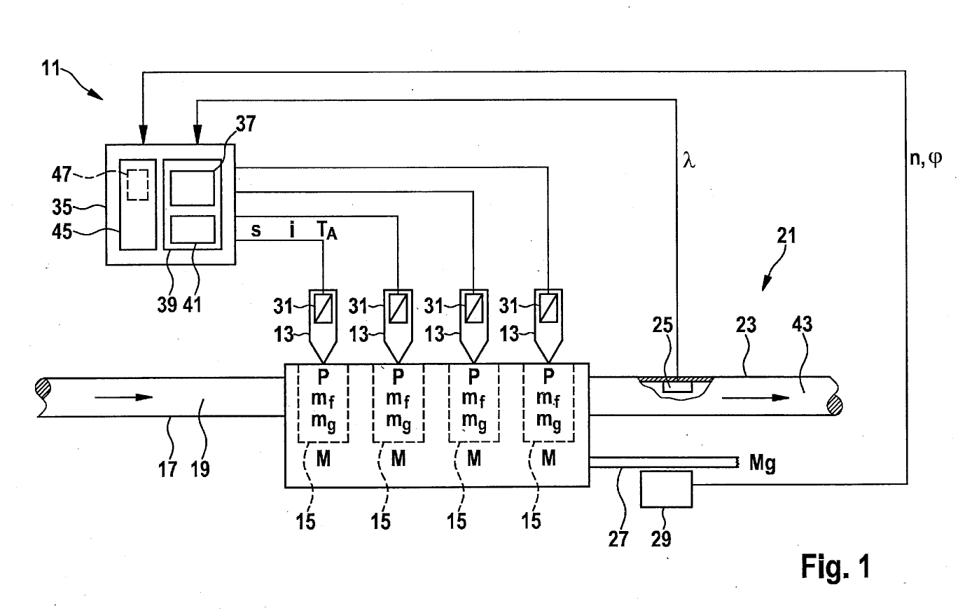

An internal combustion engine 11 shown in FIG. 1 is preferably a gasoline engine having direct gasoline injection. Accordingly, internal combustion engine 11 has multiple injectors 13, a combustion chamber 15 (cylinder) being associated with each injector 13, so that injector 13 is able to inject fuel directly into the particular combustion chamber 15. Internal combustion engine 11 also has an air supply line designed as an intake manifold 17, for example. Via intake manifold 17, combustion chambers 15 may be supplied with fresh air 19 from the surroundings of internal combustion engine 11 via open intake valves (not shown). In a gas exchange cycle of a combustion chamber 15, the combustion chamber may be filled with a certain fresh gas charge of mass m_{g}.

Internal combustion engine 11 has an exhaust gas system 21 having an exhaust pipe 23. When the exhaust valves (not shown) of combustion chambers 15 are open, gas, preferably exhaust gas, is able to flow from combustion chambers 15 and into exhaust pipe 23. An oxygen sensor of exhaust gas system 21, designed as a lambda sensor 25, is situated in exhaust pipe 23.

Each of combustion chambers 15 has a piston which is supported so as to be movable back and forth in the combustion chamber, and which is coupled in a known manner to a crankshaft 27 of internal combustion engine 11 in such a way that energy generated during combustion of fuel within combustion chamber 15 is converted into a torque M, which acts on crankshaft 27. Torque M is a torque M which is individual for each combustion chamber and which contributes to the formation of an overall torque M_{g} on crankshaft 27.

A rotational speed sensor 29 which is designed for detecting a rotational speed n of internal combustion engine 11 is situated on crankshaft 27 of internal combustion engine 11. In one specific embodiment of the present invention, it may be provided that instantaneous rotation angle φ of crankshaft 27 may also be detected with the aid of rotational speed sensor 29.

A coil 31 of an electromagnetic actuating device (not provided with a reference numeral) of each injector 13 is connected to a control output of a control unit 35 for controlling and/or regulating internal combustion engine 11, so that control unit 35 is able to control individual injectors 13 for injecting a fuel quantity (mass m_{f}) which is specifiable by control unit 35.

To generate an appropriate actuating signal s, control unit 35 has an output stage 37 of a control circuit 39. Control circuit 39 of control unit 35 also includes a measuring circuit 41 for detecting the variation over time of a current through coil 31 of individual injectors 13. With the aid of actuating signal s, control unit 35 is able to control injectors 13 for opening and for closing. The period of time between the control for opening a certain injector 13 and the control for closing this injector 13 corresponds to a control period T_{A}. In the specific embodiment shown, control period T_{A} corresponds to a duration of an energization of coil 31 of this injector 13. In some specific embodiments of the present invention, control period T_{A} may correspond to a width of a control pulse of actuating signal s.

Furthermore, lambda sensor 25 is connected to an input of control unit 35, so that control unit 35 is able to detect an instantaneous excess air factor λ of exhaust gas 43 flowing from combustion chambers 15.

Control unit 35 has a computer, for example a microcontroller 45. The computer or microcontroller 45 may have a memory element, in particular a semiconductor memory 47, which is programmed to carry out a method for operating internal combustion engine 11.

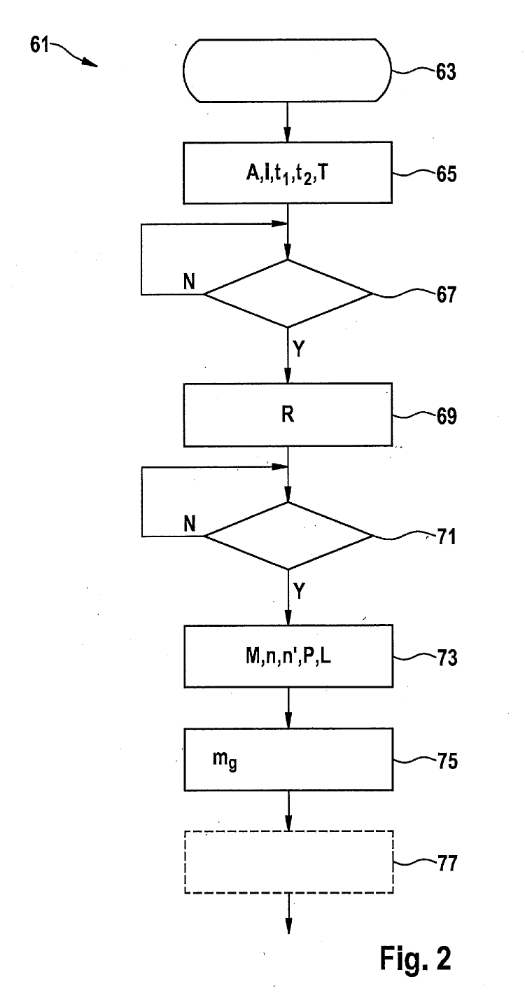

Such a method 61 is explained in greater detail below with reference to the flow chart shown in FIG. 2. After a start 63 of method 61, an adaptation operation A for adapting fuel quantity m_{f} is started in a step 65. The adaptation operation compensates for tolerances of individual injectors 13 with respect to a relationship between the control of injectors 13 with the aid of actuating signal s and fuel quantity m_{f} resulting from the control, provided that the tolerances result from deviations in a valve opening period T. In this adaptation operation A, measuring circuit 41 detects a current through coil 31 of each injector 13. Based on current i, control unit 35 ascertains the point in time when injector 13 has actually opened or closed. These points in time are recognized as a characteristic feature of the variation of current i over time, which are caused by a valve needle of injector 13 impacting injector 13 during opening or closing, resulting in reactions on current i through coil 31.

By comparing the points in time of the opening and the closing of injector 13, based on current i, to the known variation of actuating signal s over time, control unit 35 individually ascertains an opening delay time t₁, a closing delay time t₂, and/or a valve opening period T for each injector 13. Opening delay time t₁ is the delay between a start of the control with the aid of actuating signal s for opening injector 13, i.e., a start of an energization of coil 31, and the actual opening of the injector, i.e., an impact of the valve needle in a position of the valve needle in which injector 13 is open. Closing delay time t₂ is a delay between a start of the control for closing injector 13 with the aid of actuating signal s, i.e., an end of the energization of coil 31, and an actual closing of injector 13, i.e., an impact of valve needle 31 in a position of the valve needle in which injector 13 is closed, for example an impact on a valve seat.

Based on valve delay times t₁, t₂, control unit 35 corrects the point in time and the duration of the energization of coil 31 with the aid of actuating signal s in such a way that a fuel quantity m_{f}, specified by other functions of control unit 35 not described here, is injected into individual combustion chambers 15. As a result of valve delay times t₁, t₂ being ascertained for each injector 13 and being taken into account when actuating signal s is generated, manufacturing tolerances or age-related tolerances are at least largely compensated for with respect to the relationship between a control period, i.e., a period of the energization of coil 31, and a period of time in which injector 13 is open (valve opening period T).

Multiple measurements of the variation of current i over time may be necessary for adaptation operation A. It may be provided that valve delay times t₁, t₂ are ascertained for various operating states of internal combustion engine 11, for example for various values of a fuel pressure in a high-pressure fuel accumulator (not shown). As a result, a check is made in a step 67 as to whether sufficient measurements of the variation of current i over time or sufficient values of valve delay times t₁, t₂ have been ascertained; i.e., a check is made as to whether adaptation operation A is in a steady state. If this is not the case (N), branch 67 is repeated. Otherwise (Y), method 61 is continued with a step 69.

A control operation R for controlling the excess air factor which is individual for each combustion chamber is started in step 69. According to this control operation R, with the aid of lambda sensor 25, control unit 35 separately detects excess air factor λ for each combustion chamber 15, and, if necessary, changes manipulated variables of internal combustion engine 11 in order to approximate detected value λ of the excess air factor to a predefined setpoint value. For example, fuel quantity m_{f} may be changed as a function of detected excess air factor λ. In a departure from the shown specific embodiment, step 69 may also be carried out at an earlier point in time in the sequence of method 61. For example, the control operation may be started immediately after start 63 of the method, or after step 65.

A check is subsequently made in a step 71 as to whether the above-described control operation of the lambda regulation for each individual combustion chamber has reached a steady state, i.e., whether the values of excess air factor λ detected for individual combustion chambers 15 have sufficiently closely approached the setpoint value, which may be λₛₑₜₚₒᵢₙₜ=1, for example, and/or whether detected value λ varies about the setpoint value with a sufficiently small amplitude. If it is recognized that lambda regulation R for individual cylinders has not yet reached a steady state (N), step 71 is repeated. Otherwise (Y), the method continues with a step 73.

Torque M which is individual for each combustion chamber is ascertained in step 73. Instantaneous rotational speed n of crankshaft 27 is detected for this purpose. It may be provided that rotational speed n for a rotation angle range of crankshaft 27 (or a corresponding time interval) is evaluated in which a certain combustion chamber contributes to the generation of overall torque M_{g}. The particular torque M may thus be ascertained for each combustion chamber 15 in succession. For example, a change n′ in the rotational speed over time, i.e., a derivative of the rotational speed as a function of time, may be used as a measure of torque M. A combustion chamber pressure p inside individual combustion chambers 15 may also be detected with the aid of a combustion chamber pressure sensor, and torque M may be ascertained at least on the basis of combustion chamber pressure p and/or its variation over time. Alternatively or additionally, internal combustion engine 11 may have a torque sensor for detecting torque M and/or overall torque M_{g}, and torque M or overall torque M_{g} may be detected in step 73 with the aid of the torque sensor. In addition, a parameter L which characterizes uneven running of internal combustion engine 11 may be ascertained.

Since deviations in injected fuel quantity m_{f} as a function of tolerances of injector 13, in particular of valve delay times t₁, t₂, are at least largely compensated for with the aid of adaptation A of the control of injectors 13, it may be assumed with a fairly high level of certainty that differences among torques M which are individual for each combustion chamber are caused primarily by differences between fresh gas charges m_{g} of individual combustion chambers 15. Based on torques M for each combustion chamber 15, corresponding fresh gas charge ms may be computed in step 75 following step 73. Alternatively or additionally, differences between individual charges m_{g} may be computed. In general, there is a proportionality between torque M and fresh air charge m_{g}, so that when the proportionality constant is known, fresh air charge mₛ or the differences between fresh air charges mₛ of individual combustion chambers 15 may be computed. Torques M which are individual for each combustion chamber and parameter L for uneven running are influenced by multiple variables, for example a deviation in fuel quantities m_{f} between individual combustion chambers 15, deviations in fresh air charges m_{g} among individual combustion chambers 15, and deviations in an ignition angle between individual combustion chambers 15. However, since the deviations between individual combustion chambers 15 regarding fuel quantity m_{f} have been at least largely eliminated with the aid of adaptation operation A, it may be concluded that deviations in individual torques M and uneven running L are caused primarily by deviations among fresh air charges m_{g}. The deviations in the ignition angle have a relatively minor influence on the differences between the torques, or on uneven running L.

In another specific embodiment of method 61, a step 77 is provided in which the differences between torques M or uneven running L are reduced. It may be provided, for example, that for a combustion chamber 15 which in comparison to the other combustion chambers 15 generates a relatively small torque M and thus causes uneven running of internal combustion engine 11, fuel quantity m_{f} is increased. However, since increasing fuel quantity m_{f} may result in increased pollutant emissions, for example emissions of soot, in particular when internal combustion engine 11 is started and when the load on internal combustion engine 11 is low, it is preferred that fuel quantity m_{f} is changed only when internal combustion engine 11 is not in a starting operation, and/or when the load on the internal combustion engine is greater than a predefined minimum value or corresponds to this minimum value. For example, overall torque M_{g} may be provided as a measure for the load on the internal combustion engine. The minimum value would then correspond to a minimum overall torque.

In some cases, for individual injectors 13 a deviation may also occur with respect to a relationship between an actual valve opening period and injected fuel quantity m_{f}. Thus, for the same valve opening period T, fuel quantity m_{f} injected into various combustion chambers is different. This deviation may be caused by wear on injector 15 or by deposits, in particular deposits of soot or carbonization on injector 15. Adaptation operation A is not able to compensate for this deviation, since adaptation operation A is able to recognize only deviations with respect to a relationship between the control period (i.e., the energization period of coil 31) and the actual opening time of injector 13. However, these deviations could be compensated for in step 77.

In order to compensate for different torques M or to reduce uneven running L, or additionally or alternatively to change fuel quantity m_{f}, in step 77 it is conceivable to adjust an ignition angle for the particular combustion chamber 15 or the particular combustion chambers 15 whose torque M deviates from a desired torque, or from torque M which is generated by other combustion chambers 15. Torques M of individual combustion chambers 15 may be at least approximately equalized in this way.

Method 61 shown in FIG. 2 may be carried out regularly, for example periodically, during operation of internal combustion engine 11 when certain operating states occur, or when a change is made between operating states of internal combustion engine 11.

In one specific embodiment not shown, for individual combustion chambers 15 the excess air factor which is individual for each combustion chamber is not adjusted. In this case, step 69 and branch 71 may be dispensed with.

In another specific embodiment not shown, the torque which is individual for each combustion chamber is not ascertained. In this case, steps 75 and 77 may be dispensed with.

Overall, the present invention provides method 61 for operating internal combustion engine 11, which allows various adaptation and control processes for controlling and/or regulating fuel quantity m_{f} and fresh gas charge m_{g} to be coordinated and matched to one another in such a way that tolerances of individual injectors 13 are compensated for, and at the same time, direct feedback and faulty adaptations are at least largely avoided.

1-10. (canceled)

11. A method for operating an internal combustion engine having multiple combustion chambers, wherein an injector for injecting fuel is associated with at least one combustion chamber, the method comprising:
adjusting an excess air factor for at least one combustion chamber, wherein each combustion chamber has an associated individual excess air factor;
adapting, with the aid of an adaptation operation, a control period of the injector by one of detecting or ascertaining a valve opening period of the injector in such a way tolerances of the injector are at least essentially compensated for with respect to a relationship between the control period and the valve opening period;
determining whether the adapting of the control period of the injector has reached a steady state; and
ascertaining a torque for the at least one combustion chamber, wherein each combustion chamber has an associated individual torque, wherein the individual torque for the at least one combustion chamber is not ascertained until the adapting of the control period of the injector has been determined to have reached a steady state.

12. The method as recited in claim 11, wherein in the adapting of the control period, at least one valve delay time of the injector is ascertained by detecting and evaluating a variation over time of at least one electrical variable for an electrically activated actuator of the injector.

13. The method as recited in claim 12, wherein at least one of the following quantity is ascertained as the valve delay time:
(i) an opening delay time between a start of a control for opening the injector and an actual opening of the injector; and
(ii) a closing delay time between a start of a control for closing the injector and an actual closing of the injector.

14. The method as recited in claim 12, wherein the adjusting of the excess air factor for the at least one combustion chamber is not started until the adapting of the control period of the injector has been determined to have reached a steady state.

15. The method as recited in claim 12, further comprising:
determining whether the adjusting of the excess air factor has reached a steady state;
wherein the individual torque for the at least one combustion chamber is not ascertained until the adjusting of the excess air factor has been determined to have reached a steady state.

16. The method as recited in claim 12, wherein in ascertaining the individual torque for the at least one combustion chamber, at least one sensor variable which characterizes at least one of the following quantities is detected: a combustion chamber pressure in the at least one combustion chamber; a rotation angle of a shaft of the internal combustion engine; and a rotational speed of the shaft of the internal combustion engine.

17. The method as recited in claim 16, wherein in ascertaining the individual torque for the at least one combustion chamber, a variable which characterizes uneven running of the internal combustion engine is computed.

18. An internal combustion engine system, comprising:
multiple combustion chambers;
an injector for injecting a fuel quantity into at least one combustion chamber; and
a control unit including:
means for adjusting an excess air factor for at least one combustion chamber, wherein each combustion chamber has an associated individual excess air factor;
means for adapting, with the aid of an adaptation operation, a control period of the injector by one of detecting or ascertaining a valve opening period of the injector in such a way tolerances of the injector are at least essentially compensated for with respect to a relationship between the control period and the valve opening period;
means for determining whether the adapting of the control period of the injector has reached a steady state; and
means for ascertaining a torque for the at least one combustion chamber, wherein each combustion chamber has an associated individual torque, wherein the individual torque for the at least one combustion chamber is not ascertained until the adapting of the control period of the injector has been determined to have reached a steady state.
